(19) United States
(12) Patent Application Publication
(10) Pub. No.: US 2006/0237150 A1
(43) Pub. Date: Oct. 26, 2006

(54) Shaft coupling for barrier movement operators

(75) Inventor: Robert J. Olmsted, Wood Dale, IL (US)

Correspondence Address: FITCH EVEN TABIN AND FLANNERY, 120 SOUTH LA SALLE STREET, SUITE 1600, CHICAGO, IL, 60603-3406, US

(73) Assignee: The Chamberlain Group, Inc.

(21) Appl. No.: 11/111,361

(22) Filed: Apr. 21, 2005

(51) Int. Cl. E05D 15/06

(52) U.S. Cl. 160/200

(57) ABSTRACT

A barrier movement or garage door operator has a jack shaft connected to an output shaft delivering power to move a barrier or garage door between open and closed positions, the jack shaft and output shaft being connected by a coupling. The coupling, jack shaft, and output shaft are fixed relative to each other. The coupling connects the jack shaft and output shaft for rotation around a common axis. The coupling receives a portion of the jack shaft and output shaft for securing the shafts within the coupling by compressing against an outer surface of each shaft. The shafts may be cylindrical, and the compressive force may be distributed around the cylindrical outer surface of the shafts. The coupling may have a portion sized to correspond to respective predetermined diameters or sizes of the shafts.

### FIELD OF THE INVENTION

The invention relates to a barrier movement or garage door operator, in particular, to a jack shaft operator having a coupling for connecting a power shaft to a jack shaft for operating the barrier or garage door.

### BACKGROUND OF THE INVENTION

In general terms, a barrier such as a garage door is installed on a pair of rails having generally vertical portions positioned proximate the sides of a garage opening and having generally horizontal portions extending away from the opening into the interior of the garage. The garage door is moved along the rails to shift between a generally closed position within the garage opening and between the vertical rail portions, and a generally open position away from the garage opening and between the horizontal rail portions. A garage door operator is used to drive the movement of the garage door between the open and closed positions.

Currently, jack shaft garage door operators are well-known for driving the movement of a garage door. The door operator includes a generally vertically extending cable having a first end secured to a lower portion or panel of the garage door. The door operator exerts tension on the cable to lift and shift the garage door from the closed position to the open position. The cable has a second end connected to a pulley. In order to exert tension on the cable, the door operator rotationally drives the pulley so that the cable is wound around the pulley, thereby shortening the distance between the pulley and the cable first end, as well as between the pulley and the lower portion of the garage door being raised.

The pulley is located on and secured with a jack shaft extending parallel to the garage opening. As the cable is attached to a lower portion of the door and within the rails, the pulley and jack shaft are positioned so that movement of the door does not interfere with operation of the pulley. The jack shaft is typically a torsion bar which can include either a coil spring or extension springs to provide a spring bias to the pulley tending to draw the garage door toward the open position. However, the bias is insufficient to overcome the weight of the door without additional power being provided to the pulley.

The additional power for overcoming the door weight to open the garage door is provided to the pulley by a drive system, typically an electric motor driving an output power shaft extending from a housing of the drive system. The power shaft and pulley are operably coupled with a transmission system which may include a belt or drive chain for driving sprockets respectively fixed on the power shaft and jack shaft or its pulley.

The drive system is mounted to a wall in a position outside of the opening and rails. The power shaft extends from the housing a short distance toward a first rail with its sprocket located on and end thereof. The drive chain extends vertically, either upwardly or downwardly, between the power shaft sprocket and the jack shaft sprocket. Accordingly, the jack shaft must extend beyond at least one of the rails, and the sprockets are aligned to rotate generally in the same plane.

Such an arrangement presents a number of issues. Because of the transmission including the sprockets and chain, the system has particular space requirements for installation. A certain precision must be provided in aligning the sprockets to generally rotate in the same plane, and a certain amount of precision must be provided in mounting the drive system to provide the chain with the proper amount of tension between the sprockets.

Additionally, the sprockets have an annular hub or collar, and securing the sprocket hub to their respective shaft presents further problems. One approach for securing the hub is with set screws which are known to loosen over time, allowing the sprocket to slip. Set screws can also compress a hollow shaft or bar, leading to stress concentrations and failure of the system including twisting or deflection of the shaft.

Another manner for securing the sprocket to a shaft is with some type of keyed mating such as drilling a hole through the hub and its shaft, and inserting a pin therein. This method is labor intensive, incurring additional costs in machining and milling the surfaces, and stress concentrators may be produced which may lead to damage and failure. Additionally, such mating reduces the flexibility in mounting the components of the system, such as the drive system, as the sprockets are to be aligned to rotate in the same plane.

Some of the problems with securing the sprockets may be overcome by using a solid shaft. However, a solid shaft significantly increases the cost of the component, as well as significantly increases the weight such that an increase in the operational torque of the motor is needed.

Accordingly, there has been a need for an improved jack shaft door operator.

### SUMMARY

A jack shaft barrier movement or garage door operator is disclosed herein for opening and closing a movable barrier or garage door. The garage door operator includes an electric motor for rotationally driving a power shaft operably connected to a jack shaft having a pulley thereon. The pulley has a cable secured thereto such that rotation of the jack shaft rotates the pulley and causes the cable to be wound around the pulley. An end of the cable is secured to a lower portion or panel of the garage door so that winding of the cable around the pulley draws the lower portion of the garage door towards the pulley, thereby lifting the door and moving the door along its track or rails from a closed position to an open position.

The jack shaft and the power shaft are connected by a compression coupling. In this manner, the jack shaft and power shaft are fixed relative to each other. Each shaft has a coupling end that is inserted into a portion of the coupling and is compressed therein. This eliminates the need for the sprocket system and its above-described problems. For instance, the coupling is compressed in a radially inward manner against a entire circumference of the shaft, avoiding the issues of the set screws or keyed mating. The coupling is removable and may be placed on either end of the shaft, facilitating different mounting conditions and not requiring a pre-drilled hole in the shaft for pinning a sprocket thereon. Elimination of the belt or chain drive eliminates tensioning issues with the chain drive, and allows the drive system to be installed by simply aligning the shafts relative to each other. Alignment of the shafts is achieved easily by securing the shafts in the coupling. As the sprockets are not necessary, alignment of the sprockets for co-planar rotation is not necessary.

The drive system can be placed in a number of positions by securing the shafts directly with the coupling. For instance, when lateral clearance outside of the rails is minimal, the jack shaft can be shortened and the drive system can be located above the door opening without needing to be offset a distance to provide for the sprocket and chain transmission system. In addition, the space requires for the operator are reduced as the drive system can be mounted at the end of the jack shaft and close to the rail.

In one form, the coupling is a double split-ring, one split-ring for each of the shafts to be connected by the coupling. Both rings are joined to form a base portion and have respective compressive portions. In one form, the rings have different internal diameters sized generally for respective shafts having different external diameters, such as the jack shaft and output power shaft. Accordingly, a shoulder is formed between the rings. In some forms, the larger of the shafts may be inserted in the larger internal diameter ring of the coupling to a depth to contact the shoulder and be secured therein. The other shaft is then inserted in the other ring to an appropriate depth and secured therein. In the event the larger shaft is hollow, the smaller shaft may be received by both the coupling and the larger shaft.

In some forms, the coupling is a unitary member having a base and a pair of deflectable portions in the form of arms extending from the base. One end of each arm is secured to the coupling base, and the other end is generally free prior to installation. To couple the shafts, the free ends of the arms are secured relative to the base. A shaft is inserted within the base and an arm, and the arm free end is drawn toward the base such that an interior surface of the base and arm compress radially inwardly on the outer, circumferential surface of the shaft.

In other forms, the coupling has a partial-circular base and two partial-circular arms, each having two free ends that are securable to the base to form a complete circle. Each shaft may be positioned between an arms and the base, and the arm is then secured to the base to compress the circumference of the shaft.

The coupling generally defines an internal cavity for receiving the ends of the jack shaft and output power shaft such that the coupling provides an overlapping connection with of the shafts. Each shaft may have a predetermined outer diameter, and the internal cavity may have a predetermined inner diameter generally sized with respect to the diameters of the shafts. Once the shafts are received therein, at least a portion of the coupling is compressed against the shaft. In one form, the coupling includes compressing portions that are deflected toward a base to compress the shafts therebetween are moved toward a base to reduce size of the internal cavity. In another form, the coupling includes compressing portions that are moved toward a base to compress the shafts therebetween.

### BRIEF DESCRIPTION OF THE DRAWINGS

In the drawings, FIG. 1 is fragmentary perspective view of a garage having a garage door in a closed position with a jack shaft garage door operator attached to the garage door for moving the door between the closed position and an open position, the door operator including a drive system and an output shaft connected to a jack shaft by a coupling;

FIG. 2 is a first fragmentary perspective view of the coupling connected to the jack shaft and to the output shaft, and the door operator having a housing partially cut-away to show the output shaft;

FIG. 3 is a prior art perspective view of a door operator having an output shaft operably connected to a shaft by a sprocket and chain or belt drive transmission;

FIG. 4 is a second fragmentary perspective view of the door operator showing the coupling secured on the jack shaft;

FIG. 5 is a third fragmentary perspective view showing the coupling secured on the jack shaft, the door operator housing and output shaft in phantom, and the jack shaft extending through a hollow center of the output shaft;

FIG. 6 is a first perspective view of a form of the coupling showing a base portion and a pair of deflectable portions;

FIG. 7 is a second perspective view of the coupling of FIG. 5 showing clamping bores;

FIG. 8 is a first side elevational view of the coupling of FIG. 5 showing internal diameters of the coupling;

FIG. 9 is a second side elevational view of the coupling of FIG. 5 showing a gap between a free end of the deflectable portions and the base; and

FIG. 10 is a second form of a coupling showing a base and a pair of compression portions securable to the base.

### DESCRIPTION

Referring initially to FIG. 1, a garage door operator 20 having a shaft coupling 30 embodying aspects of the present invention is depicted. The door operator 20 is secured to an interior wall 3 of a garage 1 proximate a garage opening 2. The garage opening 2 is covered by a garage door 4, depicted in a closed position. The door operator 20 functions to move the garage door 4 from the closed position to an open position to allow passage through the garage opening 2. The garage door 4 is represented as having four panels 5 connected by hinges 6, and has wheels (not shown) secured to the lateral sides 5a, 5b of the panels 5. The wheels are located within rails 7a, 7b having a generally vertical sections 8 secured to the wall 3 and to a garage floor 11, and having generally horizontal sections 9 secured to a ceiling 12. When the garage door 4 is moved to the open position, the panels 5 are guided along the rails 7a, 7b by the wheels. The rails 7a, 7b further have curved transition portions 10, and the panels 5 pivot relative to each around the hinges 6 to allow the panels 5 to move between the vertical and horizontal sections 8, 9.

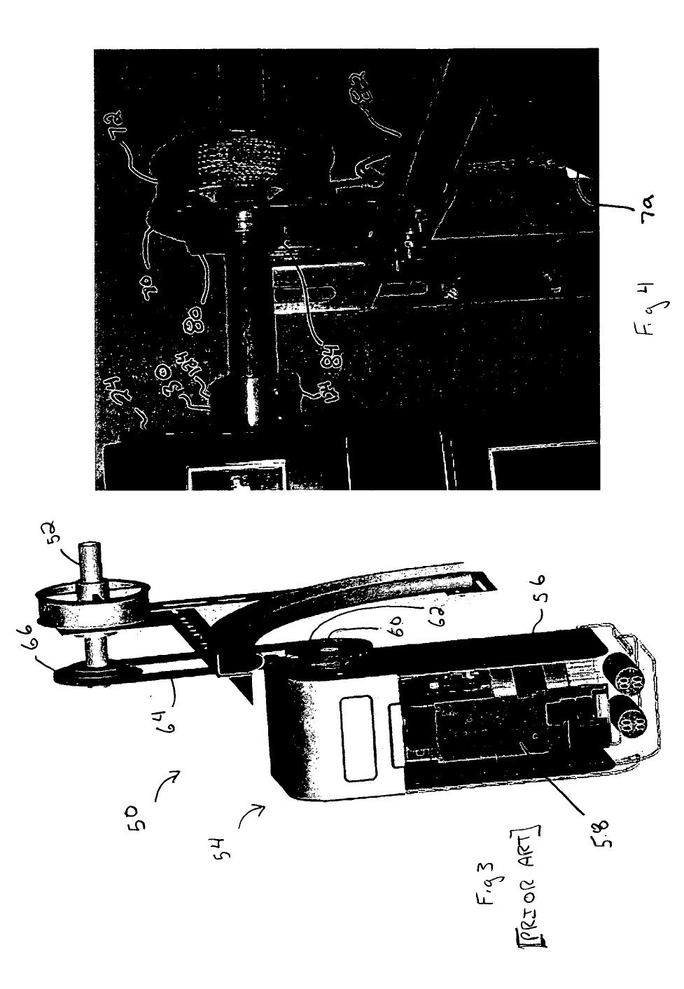

The door operator 20 includes a jack shaft 22 positioned above the opening 2 and a drive system 24 positioned lateral to the opening 2. The drive system 24 includes an output power shaft 26 connected to the jack shaft 22 by the coupling 30. Thus, when the power shaft 26 is rotated, such as by an electric motor 28 (see FIG. 3), the jack shaft 22 is directly rotated to raise the garage door 4, as will be discussed below.

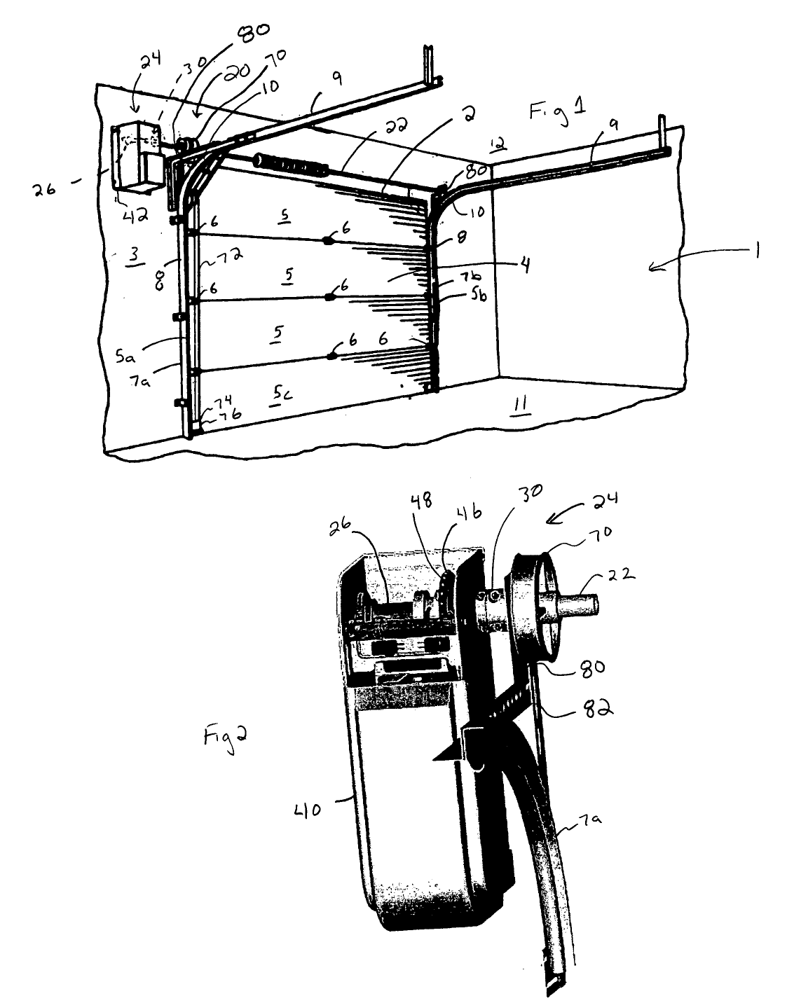

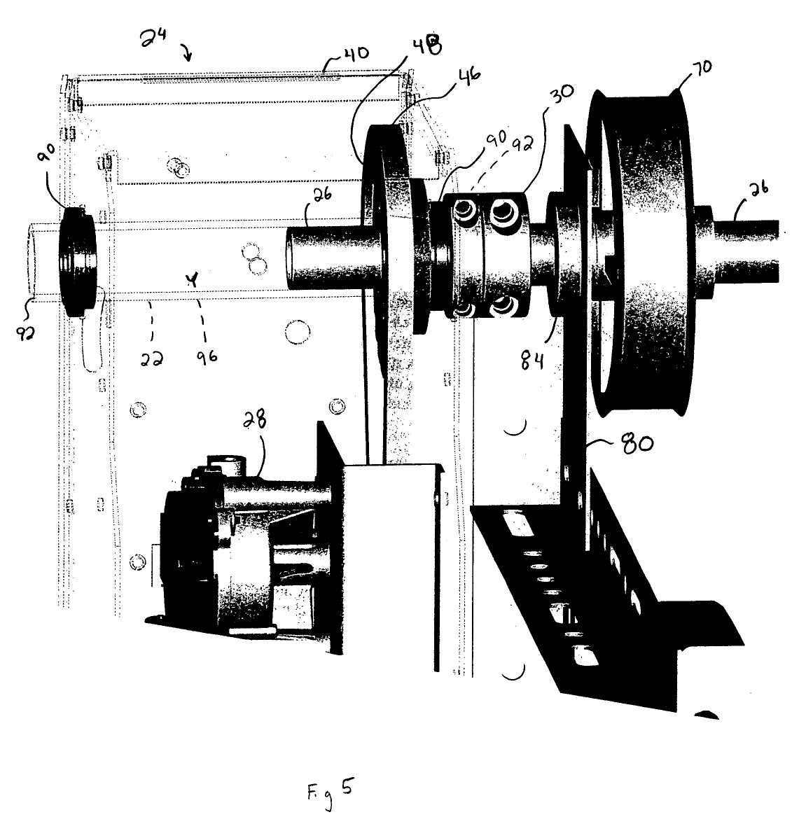

As can be seen in FIGS. 2 and 5, the drive system 24 includes a housing 40 secured to the wall 3, such as by a bracket 42 (FIG. 1). The drive system 24 includes the electric motor 28 providing a sufficient torque for moving the garage door 4. As depicted, the motor 28 is operably connected to the power shaft 26 with a belt or chain 46 to a sprocket 48 or the like secured to the power shaft 26. As is known in the art, the electric motor 28 has a rotor (not shown) rotationally driving a motor axle (not shown) having an output sprocket or pulley (not shown). It should be noted that the motor 28 alternatively may be alternatively a direct drive motor with the power shaft 26 being the motor axle, or the motor 28 may be connected to the power shaft 26 via another transmission system, such as a geared transmission. A desired gear ratio for providing a desired speed and torque from the motor to the power shaft can be produced by proper selection of the size of the sprocket 48 relative to the output sprocket, or by a geared transmission, for instance.

As shown in FIGS. 1,2 and 5, the jack shaft 22 and the power shaft 26 are co-axially aligned. More specifically, the coupling 30 receives an end of each of the power shaft 26 and jack shaft 22 to secure the shafts 22, 26 together in the co-axial arrangement. In this manner, rotation of the power shaft 26 causes equal rotation of the jack shaft 22, as will be described below.

In contrast, a prior art operator 50 is shown in FIG. 3 without the coupling 30. The prior art operator 50 includes a jack shaft 52, and a drive system 54 for rotating the jack shaft 52 to move the garage door 4. The operator 50 includes a housing 56 and an electric motor 58 coupled to a power shaft 60, with or without a chain drive (not shown) within the housing 56. The power shaft 60 extends from the housing 56 towards the garage opening 2 and includes a sprocket 62 secured thereto. The sprocket 62 drives a chain or belt 64 connected to a sprocket 66 located on the jack shaft 52. As can be seen, the position of the prior art operator 50 is offset from the jack shaft 52, requires an increased number of components than the door operator 20 of the present invention, requires alignment of the sprockets 62, 66 to rotate in a common plane, requires tensioning of the chain 64, and requires securing the sprockets 62, 66 to their respective shafts 52, 60. The operator 20 of the present invention each of these problems is reduced or eliminated by use of the coupling 30.

Referring to FIGS. 2 and 4, the operator 20 is provided with a pulley 70 and cable 72 to raise or lower the garage door 4. The pulley 70 is attached to the jack shaft 22, as can be seen in FIG. 4, while the cable 72 has a lower end 74 connected at a lower portion 76 of the garage door 4, such as the bottom panel 5c. The cable 72 has a portion wound around the pulley 70 and secured thereto. When the jack shaft 22 is rotated, the pulley 70 is also rotated so that the cable 72 is either payed-out from or wound-up on the pulley 70. That is, when the pulley 70 rotates in a first direction, the cable 72 is wound around the pulley 70 so that the distance from the pulley 70 to the cable lower end 74 is shortened and the door lower portion 76 is drawn toward the pulley 70. When the pulley 70 is rotated in a second direction opposite from the first, the cable 72 is payed-out from the pulley 72 so that the door 4 is lowered.

The pulley 70 is positioned close to a support bracket 80 secured to a rail frame 82, itself secured with the rail 7a. The support bracket 80 includes a bearing 84 for allowing rotation of the jack shaft 22 within the support bracket 80. The bracket 80, frame 82, and bearing 82 provided support for the jack shaft 22. With reference to FIG. 1, a support bracket 80 is provided at preferably both ends of the jack shaft 22 and secured to each rail 7a, 7b. The pulley 70 is preferably proximate the support bracket 80 to reduce the moment arm or torque exerted by the tension on the cable during operation. In the prior art operator 50 (FIG. 3), deflection of the jack shaft 22 due to tension on the cable 72 may cause the sprocket 66 to deflect out of its proper plane of rotation, resulting in excessive wear against the chain 64 and possibly cause the chain 64 to jump from the sprocket 66.

By eliminating the sprockets 62, 66 of the prior art operator 50, any deflection experienced is transmitted directly through to the power shaft 26 where it has minimal effect. The power shaft 26 is relatively short and is secured within the housing 40 by a pair of bearings 90 positioned at each end 92 of the power shaft 26. In this manner, the power shaft 26 is constrained from shifting or deflecting, thereby serving to constrain the jack shaft 22 from deflection. Significant stresses exerted on the power shaft 26 would, regardless, be transmitted to the wall 3 by the bracket 42.

With specific reference to FIG. 5, the power shaft 26 and housing 40 are shown in phantom. In some forms, one of the shafts 22,26 and preferably the power shaft 26 may be hollow to provide a cavity 96 therein. The jack shaft 22 may be inserted through the coupling 30 and further into the cavity 96. This serves to further join the jack shaft 22 and power shaft 26 for rotation and relative securement, as well as reducing effects of deflection. Additionally, this facilitates different mounting conditions by reducing the need for precisely measured shafts and allows the drive system 24 to be mounted close to the rail 7a.

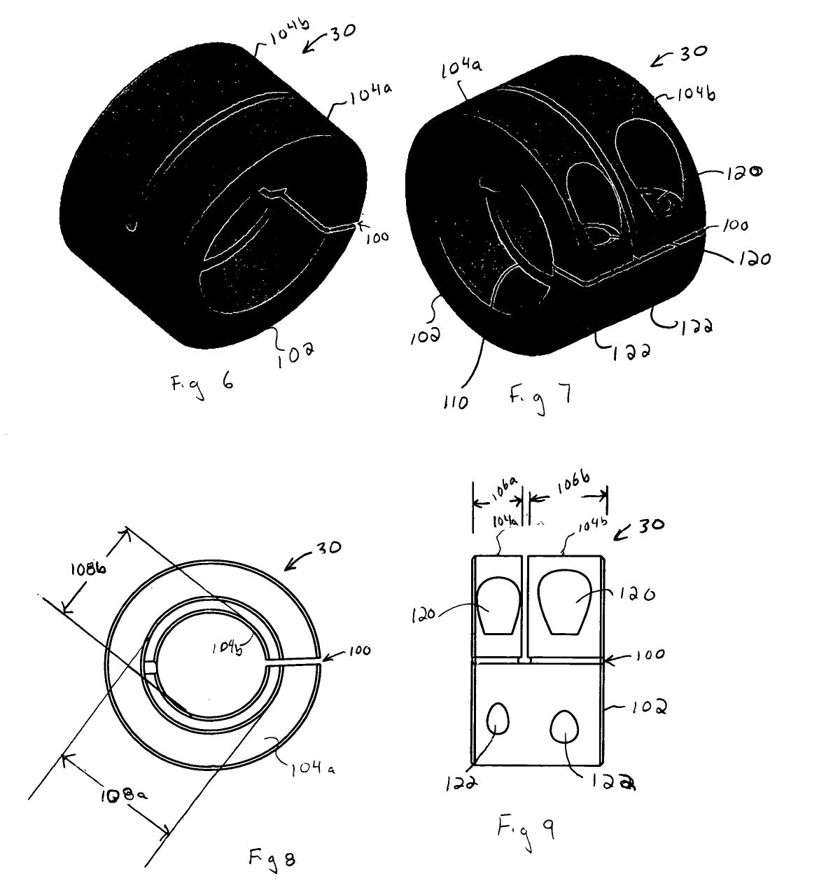

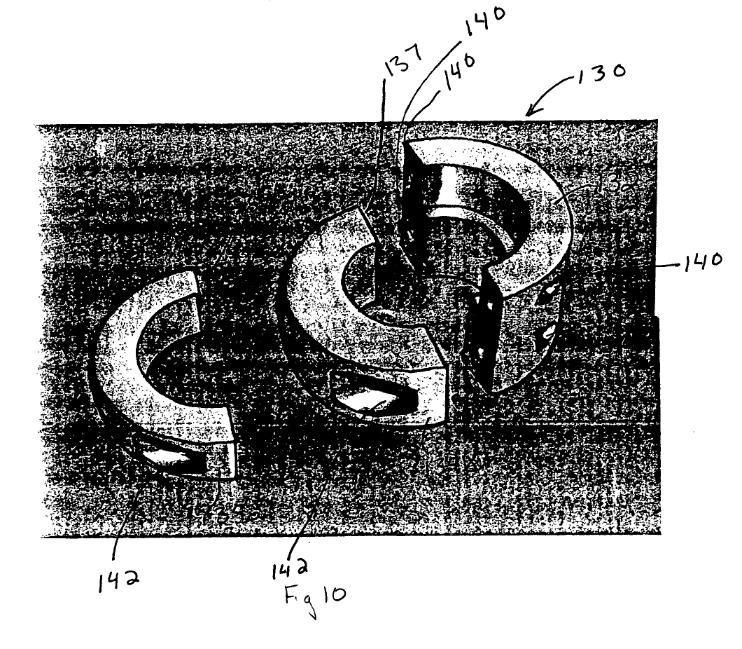

Turning now to FIGS. 6-9, a form of the coupling 30 for securing the power shaft 26 with the jack shaft 22 is depicted. Generally speaking, the coupling 30 is a split ring having a gap 100 so that the shafts 26, 22 may be received within the coupling 30, whereupon the coupling 30 is compressed to reduce or eliminate the gap 100. This compression applies radial compressive force around an entire circumference of each shaft 22, 26 located therein. The above-described problems with using set screws and keyed mating are thus eliminated, and the coupling 30 is suitable for use with both solid and hollow shafts without distorting or damaging the shaft and without creating stress concentrations.

More specifically, the coupling 30 is formed as a double split-ring where the rings are joined together for a base portion 102. The coupling 30 generally forms a C-shape and with base portion 102 generally formed as a half C-shape. A pair of generally parallel compressing portions or arms 104a, 104b are formed integrally with the base 102 and complete the C-shape having the gap 100. Each arm 104a, 104b has a respective width 106a, 106b, and the widths may be identical or one may be larger. As shown, arm 104a has a smaller width 106a than the width 106b of the other arm 104b.

The coupling 30 has an internal diameter 108 for receiving the shafts 22,26 therein. In the preferred embodiment, the coupling 30 has separate internal diameteral portions 108a, 108b generally sized for the power shaft 22 and jack shaft 26, respectively. As can be seen, the diametral portion 108a is larger than the diametral portion 108b so that the power shaft 22 may have a larger diameter than the jack shaft 26. The power shaft 22, in the form including the cavity 96, may receive the smaller jack shaft 26 within the cavity 96, and thus requires the larger diametral portion 108a within the coupling 30. Alternatively, the shafts 22, 26 may simply having different diametral sizes, in which case a coupling designed to compress the shafts 22, 26 in a generally distributed manner around the shaft circumferences is desirable. A shoulder 110 is formed between the larger and smaller diametral portions 108a, 108b. During installation, the larger of the shafts 22, 26 may be inserted into the coupling 30 while using the shoulder 110 as a stop. The larger shaft may then be secured, and the other shaft then inserted and secured. Thus, the coupling 30 provides an overlapping connection to the ends of each shaft 22, 26

In order to secure the coupling 30, holes are provided for insertion of fasteners 124 (see FIG. 4). The arms 104a, 104b are each provided with a hole 120, and the base 102 is provided with a two holes 122, each aligned with one of the respective holes 120 of the arms 104a, 104b. In the preferred embodiment, the fasteners 124 are threaded bolts. Either the holes 120 or holes 122 is an insertion hole having a larger diameter than the other holes and larger than the thread profile of the fasteners 124 so that the fastener 124 simply passes through the insertion hole. The other of the holes 122, 120 is preferably threaded to receive the fastener therein in threaded engagement. To secure the coupling 30 on the shafts 22, 26, the fasteners 124 are received by the insertion hole, either hole 120 or 122, and threads into the hole aligned with the insertion hole. As the fasteners 124 thread in, the arms 104a, 104b are compressed inwardly to compress on the shaft 22,26, and to reduce the gap 100 between the arms 104a, 104b and the base 102.

A second form of the coupling is depicted as coupling 130 in FIG. 10. The coupling 130 is similar to the coupling 30 in operation. However, the coupling 130 has a base 132, generally a half C-shape, and two arms 134a, 134b, similar to arms 104a, 104b, that are not integrally formed with the base 132. Instead, the arms 134a, 134b are secured to the base 132 at both ends 135, 137 of each arm 134. Accordingly, the base 132 is provided with holes 140, the arms 134 are provided with holes 142 which are aligned with the holes 140, and the above-described fasteners 124 are received by the holes 140, 142 to secure the arms 134 to the base 132 to compress the shafts 22, 26 within the coupling 130.

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims.

What is claimed is:

1. A barrier movement operator comprising;
a jack shaft having an outer diameter connected to a barrier;
a motor assembly having a power driven output shaft having a predetermined outer diameter;
a compression coupling having a first inner diameter for providing an overlapping connection over the jack shaft outer diameter, and providing an overlapping connection over the motor assembly power output shaft outer diameter; and
an apparatus for compressing the connection of the compression coupling to the jack shaft to the output shaft.

2. A barrier movement operator according to claim 1, wherein the power output shaft comprises a cylindrical wall deferring a hollow inner diameter, the hollow inner diameter being equal to or greater than the outer diameter of the jack shaft.

3. A barrier movement operator according to claim 2, wherein the apparatus for compressing is controlled to compress the coupling to the jack shaft after the jack shaft is inserted into the hollow inner diameter of the power output shaft.

4. A barrier movement operator according to claim 1 wherein the coupling has a second inner diameter for providing the overlapping connection to the output shaft outer diameter.

5. A barrier movement operator comprising:
a jack shaft having an outer diameter connected to a barrier and rotatable around a central axis;
a drive system delivering rotational power to an output shaft having an axis of rotation; and
a coupling co-axially connecting the jack shaft and the output shaft.

6. The barrier movement operator according to claim 5 wherein the coupling overlaps a portion of the jack shaft and the output shaft.

7. The barrier movement operator according to claim 6 wherein the coupling includes at least a first compressing portion positionable to permit a portion of the jack shaft and a portion of the output shaft to be received within the coupling, the compressing portion being deflectable to compress and secure the received portions of the jack shaft and output shaft.

8. The barrier movement operator according to claim 7 wherein the compressing portion includes an interior surface corresponding to exterior surfaces of the jack shaft and output shaft.

9. The barrier movement operator according to claim 8 wherein the interior surface is generally cylindrical, and the exterior surfaces are generally cylindrical.

10. The barrier movement operator according to claim 7 wherein the coupling includes a base, the compressing portion extends from the base and has a free end positioned a distance away from the base to receive the output shaft and jack shaft within the coupling, and securing of the coupling to the output shaft and jack shaft reduces the distance.

11. The barrier movement operator according to claim 10 wherein the compressing portion includes first and second arm portions extending from the base, and the arm portions each have an interior surface corresponding to a respective exterior surface of the jack shaft and output shaft.

12. The barrier movement operator according to claim 11 wherein the output shaft has a predetermined outer diameter, the jack shaft has a predetermined outer diameter, and the coupling has a first and second inner diametral portions corresponding to the first and second arm portions and to the output shaft outer diameter and jack shaft outer diameter.

13. The barrier movement operator according to claim 12 wherein the coupling provides radially inward compressive force distributed around a circumferential surface of the output shaft and jack shaft.

14. The barrier movement operator according to claim 12 wherein thefirst and second inner diametral portions form a shoulder stop for defining the extent one of the shafts is received within the coupling.

15. The barrier movement operator according to claim 14 wherein one of the jack shaft and output shaft has an internal cavity permitting the other shaft to be received within the cavity.

16. The barrier movement operator according to claim 7 wherein the coupling includes at least a first fastener for compressing and securing the coupling to at least one of the jack shaft and output shaft.

17. The barrier movement operator according to claim 6 wherein the coupling includes at least a first compressing portion positionable to permit a portion of the jack shaft and a portion of the output shaft to be received within the coupling, the compressing portion being shiftable to compress and secure the received portions of the jack shaft and output shaft.

18. The barrier movement operator according to claim 17 wherein a portion of the jack shaft and a portion output shaft have a cylindrical outer surface with predetermined diameters, the coupling defines an interior generally cylindrical cavity for receiving the cylindrical portion of the jack shaft and output shaft, and shifting of the compressing portion mates the cylindrical cavity with the jack shaft and output shaft.

19. The barrier movement operator according to claim 18 wherein the cylindrical cavity has first and second diametral portions sized to correspond to the predetermined diameters of the jack shaft and output shaft.

20. In combination with a barrier movement operator having a jack shaft operably connected to a barrier for moving the barrier between open and closed position, having a drive system for delivering power to an output shaft, a coupling comprising:
a first portion for receiving and compressing the output shaft with a radially compressive force distributed around a circumferential surface of the output shaft; and
a second portion for receiving and compressing the jack shaft with a radially compressive force distributed around a circumferential surface of the jack shaft, wherein the jack shaft and output shaft are relatively fixed.
